(19) United States
(12) Patent Application Publication
(10) Pub. No.: US 2018/0100699 A1
(43) Pub. Date: Apr. 12, 2018

(54) CHARGE CARRIER

(71) Applicant: SCHUNK KOHLENSTOFFTECHNIK GMBH, Heuchelheim (DE)

(72) Inventor: Bernd Groos, Wehrheim (DE)

(21) Appl. No.: 15/558,226

(22) PCT Filed: Feb. 19, 2016
(86) PCT No.: PCT/EP2016/053545

§ 371 Date: Sep. 14, 2017

(30) Foreign Application Priority Data
Mar. 19, 2015 (DE) 10 2015 205 020.3

(51) Int. Cl. F27D 3/00; F27D 3/02; F27D 5/00

(52) U.S. Cl. CPC F27D 3/0021; F27D 5/0031; F27D 5/0012; F27D 3/02

(57) ABSTRACT

The invention relates to a charge carrier (10) for the defined arrangement of processed objects, the charge carrier comprising, as components, at least a support grid (11) having a plurality of receiving elements for receiving the objects, the receiving elements being connected to the support grid in a form-fitting manner via a plug-in connection, wherein the receiving elements are designed as adapters (25) for the positioned individual reception of the objects, the adapters being received in adapter receptacles of the support grid so as to be arranged in a positioned manner.

The present invention relates to a charge carrier for the defined arrangement of processed objects, the charge carrier comprising, as components, at least a support grid having a plurality of receiving elements for receiving the objects, the receiving elements being connected to the support grid in a form-fitting manner via a plug-in connection.

Charge carriers of the kind mentioned above are used as means for temporarily arranging workpieces during temperature treatment, for example. In particular, the charge carriers are used to hold objects that are being tempered in vacuum furnaces or protective gas furnaces. Being used in this way, the charge carrier is subject to a correspondingly high temperature load, which is why the known charge carriers are made of materials that exhibit as little warping as possible on the one hand and have high temperature stability on the other hand. Hence, materials that have prevailed for charge carriers of this kind include in particular graphite, carbon fiber-reinforced carbon (CFC) and ceramic materials, such as oxide ceramics and in particular oxide-ceramic composite materials, such as what is known as OXOX materials, which comprise oxide ceramic fibers embedded in an oxide-ceramic matrix.

From DE 20 2013 011 806 U1, a charge carrier of the kind mentioned above is known, which has a plurality of receiving elements arranged on support grids, the receiving elements being designed as ceramic round rods, which are received in webs of the support grid, said webs being arranged perpendicular to the round rods and provided with receiving grooves.

The receiving elements designed as round rods do allow the contact surfaces between the receiving elements and objects placed thereon to be nearly linear, i.e. as small as possible. However, the objects will be placed loosely on the receiving elements, so their arrangement relative to the support grid is not of a positioned nature. Consequently, there are in particular random distances between the objects, and the objects resting on the receiving elements cannot be precluded from touching each other.

Therefore, the object of the present invention is to provide a charge carrier that allows defined arrangement of the objects while still allowing easy adjustment of the support grid to objects of different designs.

To attain this object, the charge carrier according to the invention has the features of claim 1.

According to the invention, the receiving elements are designed as adapters for the positioned individual receipt of the objects, the adapters being received in adapter receptacles of the support grid so as to be arranged in a positioned manner.

The charge carrier designed according to the invention thus allows dual positioning of the objects on the support grid in such a manner that the objects are positioned relative to the adapters on the one hand and the adapters are positioned relative to the support grid on the other hand by arranging the adapters in the adapter receptacles.

Independently of the material combination selected for the composition of the components, the charge carrier according to the invention has the special advantage that the combination of adapters with adapter receptacles provided in a support grid allows easy adjustment of the charge carrier for the defined arrangement of different objects by exchanging suitable adapters while the support grid stays the same.

Preferably, the support grid and the adapters are made of a material belonging to the group of materials comprising the materials CFC, graphite or oxide-ceramic material.

This makes it possible both for all components to be made of one and the same material and for the components to be made of different materials of the group of materials mentioned above, which means that, for example, the support grid can be made of CFC or of an oxide-ceramic material and the adapters can be made of graphite or of an oxide-ceramic material.

The term oxide-ceramic material as it is used here also comprises the possibility of the oxide-ceramic material consisting of oxide-ceramic composite material, i.e. of providing a body made of oxide ceramics with a basis or matrix made of a fiber structure.

It is particularly advantageous for the support grid to have at least one row arrangement of a plurality of adapter receptacles, the adapter receptacles having a receiving edge for supporting a support edge of the adapter, the receiving edge being formed by at least one web of a grid structure of the support grid and the support edge having a positioning means for the form-fitting connection to the at least one web.

In this advantageous embodiment of the charge carrier, the adapter receptacles are thus formed by the grid structure of the support grid, which means that the adapter receptacles are formed integrally in the support grid. Since the support edge of the adapter has a positioning means, it can be connected to the grid structure a form-fitting manner without needing any additional special connecting means.

If the receiving edge is designed as a closed frame having a frame opening formed in the grid structure of the support grid and the support edge, as a support frame, is provided with a frame opening, the frame openings being arranged so as to at least partially overlap each other, the charge carrier is especially suited to receive objects that penetrate the plane of the support grid and which can thus be received in the charge carrier in a particularly securely positioned manner.

It is particularly advantageous for both the receiving edge of the adapter receptacles and the support edge of the adapters to be annular, the support edge having positioning grooves as a positioning means for producing an engagement connection with the grid structure of the support grid.

Owing to the annular design of the adapter receptacles and of the adapters, they are particularly suited to receive rotationally symmetric objects, such as toothed wheels having an integrated shaft hub, which allows direct connection of the toothed wheel to a shaft, for example.

If the support edge of the adapter has contact protrusions for coming to rest on the receiving edge of the adapter receptacle, the vertical distance between the objects and the support grid can be adjusted by dimensioning the contact protrusions accordingly. It is also possible for the support edge of the adapter to be provided with contact protrusions on which the object to be received will come to rest so as to exactly position the contact surfaces in terms of their arrangement relative to the object on the one hand, so that the contact surfaces can also be used to center the object, and so as to minimize the contact surfaces between the adapter and the object on the other hand by designing the contact protrusions accordingly.

It is particularly advantageous if the same contact protrusions serve both to come to rest on the receiving edge of the adapter receptacle and to receive the object to be received.

If a releasable securing means is provided for securing the adapters in a form-fitting manner in the adapter receptacles, it is possible for the adapters to be secured to the support grid during handling of the charge carrier, if needed, without limiting the advantageous exchangeability of the adapters.

If, according to a preferred embodiment, the securing means is designed as a component that can be handled independently of the other components of the charge carrier, it is possible for the adapter to be specifically optimized for its function of receiving and arranging the objects in a defined manner without having to configure the morphology of the adapter in any special way in order to accomplish the securing function. This allows a morphologically simple configuration of the adapter and thus a design as simple as possible of the adapter, which has a positive effect both on production and on the durability of the adapter. For example, there is no need for complex connecting elements that allow a plug-in connection between the adapter and the support grid or, more precisely, the associated adapter receptacle while simultaneously securing said plug-in connection.

Like the support grid, for example, the securing means can be made of CFC or of an oxide-ceramic material.

If the securing means connects an arrangement of a plurality of adapters to adapter receptacles of the support grid, the adapters can be secured in the adapter receptacles of the support grid in a particularly economical manner.

It is also advantageous for the securing means to have at least one locking ridge that engages into a plurality of locking grooves each formed in an adapter and arranged in a shared locking row, so that the securing process can be performed by particularly simple handling of the locking ridge.

It is also especially advantageous for the securing means to be formed integrally on the support edge of the adapter so that no special components have to be provided in order to perform the securing.

According to a preferred embodiment, the securing means is formed by locking grooves which are preferably formed in a groove flank of the positioning grooves so that the positioning grooves present anyway are also used for forming the locking grooves.

If the charge carrier has a plurality of support grids arranged in a stacked arrangement and each connected to adjacent support grids via spacers, an easily effected adjustment of the charge size to the capacity of the process space in which the thermal treatment of the objects takes place is possible.

Preferably, the spacers are made of a material from the group of materials comprising the materials CFC, graphite and oxide ceramics, allowing a suitable matching of a combination of materials between the support grid and the spacers.

Hereinafter, a preferred embodiment will be explained in more detail with reference to the drawing.

In the drawing:

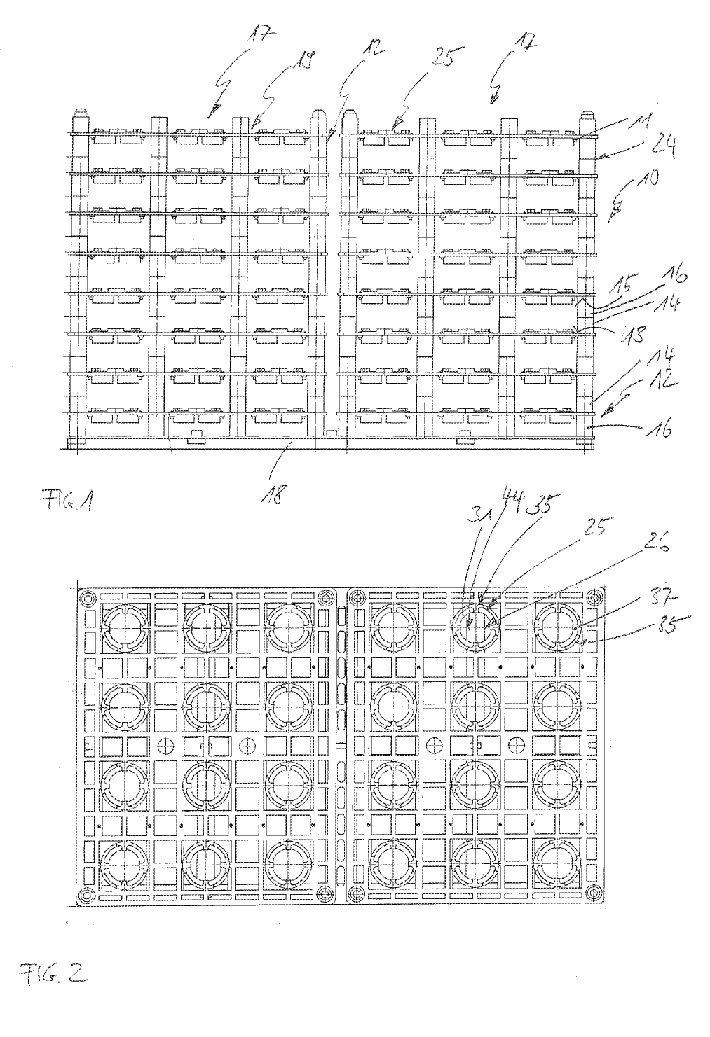

FIG. 1: shows a side view of a charge carrier having a plurality of support grids arranged in a stacked arrangement;

FIG. 2: shows a top view of the charge carrier illustrated in FIG. 1;

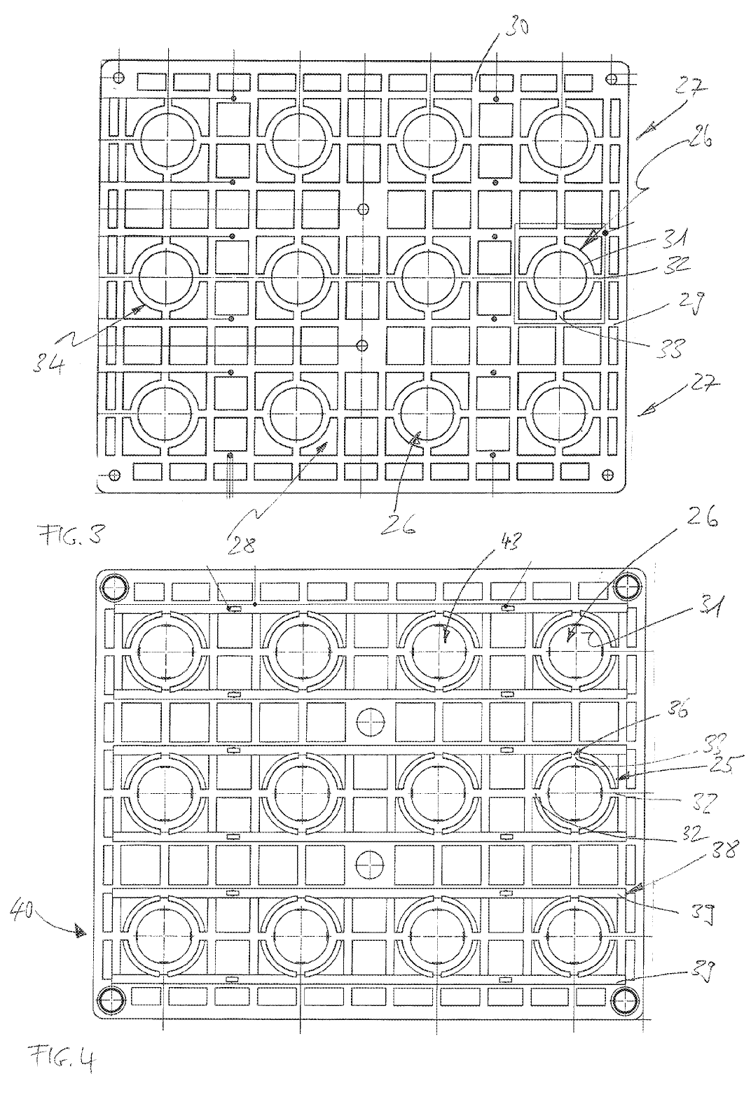

FIG. 3: shows a bottom view of a support grid of the charge carrier illustrated in FIG. 1;

FIG. 4: shows the support grid illustrated in FIG. 3 having adapters received in adapter receptacles;

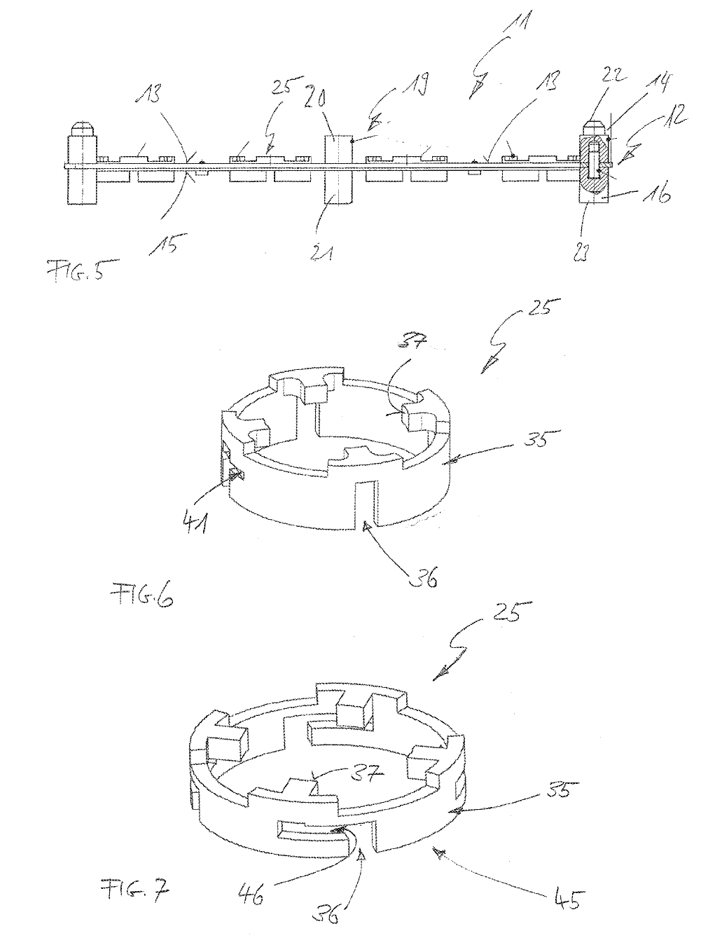

FIG. 5: shows a side view of the support grid illustrated in FIG. 4;

FIG. 6: shows an isometric illustration of an adapter;

FIG. 7: shows an isometric illustration of another embodiment of the adapter.

FIG. 1 shows a side view of a charge carrier 10 that has a plurality of support grids 11 in stacked arrangements 17, the support grids 11 being spaced apart from one another by spacers 12, which, as can be seen in particular in FIG. 5, are composed of two parts in such a manner that each spacer 12 has a spacer upper part 14 arranged on a top side 13 of the support grid 11 and a spacer lower part 16 arranged on an underside 15 of the support grid 11.

In the case at hand, the charge carrier 10 has two stacked arrangements 17 of support grids 11, which are arranged parallel to each other and on a shared charge carrier base 18. For additional central support, the support grids 11 are provided with additional spacers 19, which have a spacer upper part 20 and a spacer lower part 21, wherein, unlike spacer upper part 14 and pacer lower part 16, spacer upper part 20 and spacer lower part 21 of spacer 19 are not provided with form-fitting connecting means 22, 23, which allow a plug-in connection 24 (FIG. 1) between adjacent spacers 12.

As shown in particular in FIGS. 1 and 5, the support grids 11 are equipped with adapters 25, which are inserted into adapter receptacles 26 in the support grid 11, as illustrated in FIG. 3. To realize the adapter receptacles 26, which are arranged in multiple row arrangements 27, the support grid 11 has annular receiving edges 31 in a grid structure 28 which is formed by intersecting webs 29 running horizontally in FIG. 3 and by webs 30 running perpendicularly thereto, the annular receiving edges 31 limiting a frame opening 43 and being connected to the grid structure 28 via webs 32, 33. In the case at hand, three row arrangements 27 are arranged parallel to one another, the adapter receptacles 26 in their totality thus forming a receiving matrix 34 having adapter receptacles 26 that are regularly spaced in two axial directions.

As can be seen in particular from a combination of FIGS. 3, 5 and 6, the adapter receptacles 26 in the support grid 11 prepared for the reception of objects are equipped with the adapters 25 in such a manner that a plug-in connection is produced between the adapter receptacles 26 and the adapters 25. For producing said plug-in connection, as shown in particular in FIG. 6, the adapter 25 has a support edge 35 which is provided with positioning grooves 36 which are arranged complementarily to the webs 32, 33 in the grid structure 28 of the support grid 11. As shown in particular in FIG. 4, which shows a bottom view of the support grid 11, the production of the plug-in connection between the adapter 25 and the support grid 11 causes the adapter 25 to be arranged relative to the associated adapter receptacle 26 in such a manner that the webs 32, 33 engage into the positioning grooves 36 and the support edge 35 of the adapter 25 is arranged concentrically to the receiving edge 31 of the adapter receptacle 26, the support edge 35 limiting a frame opening 44.

Preferably, the support edge 35 of the adapter 25 conforms to the receiving edge 31 of the adapter receptacle 26. Furthermore, contact protrusions 37 are provided on the support edge 35, which project inward in the case at hand and with which the support edge 35 of the adapter 25 rests on the receiving edge 31 of the adapter receptacle 26. At the same time, the contact protrusions 37 form a physical contact with the objects (not illustrated) that are received by each adapter 26.

As shown in particular in FIG. 4, securing means 38 are provided for form-fittingly securing the adapters 25 in the adapter receptacles 26, each securing means 38 comprising at least one, but in the present case two locking ridges 39, which secure a row arrangement 40 of adapters 25, which are received in the adapter receptacles 26 of an associated row arrangement 27 (FIG. 3), in their plugged-in state connected with the support grid 11. For this purpose, the locking ridges 39 each engage into locking grooves 41 formed in the support edge 35 of the adapters 25 and arranged in a shared locking row, i.e. having a matching linear orientation, a ridge edge 42 of the locking ridges 39 thus engaging into the locking grooves 41 of the adapters 25 arranged in the same row arrangement 40.

As shown in particular in FIG. 4, opposite webs 32 and opposite webs 33 of the support grid 11 are thus fixed in the positioning grooves 36 of the adapter 25.

FIG. 7 shows an adapter 25 having a securing means 45 that is formed integrally on the support edge 35 of the adapter 25 in the manner of a bayonet lock and that has locking grooves 46 which are formed in a grove flank of the positioning grooves 36, the positioning grooves 36 present anyway thus also being used to form the locking grooves 46.

The locking is effected by a relative rotation of the adapters 25 inserted into the adapter receptacle 26 happening in the plane of the support grid 11 in such a manner that the webs 32, 33 become engaged with the locking grooves 46.

1. A charge carrier (10) for the defined arrangement of processed objects, the charge carrier comprising, as components, at least a support grid (11) having a plurality of receiving elements for receiving the objects, the receiving elements being connected to the support grid in a form-fitting manner via a plug-in connection,
characterized in that
the receiving elements are designed as adapters (25) for the positioned individual reception of the objects, the adapters being received in adapter receptacles (26) of the support grid so as to be arranged in a positioned manner.

2. The charge carrier according to claim 1,
characterized in that
the support grid (11) has at least one row arrangement (27) of a plurality of adapter receptacles (26), the adapter receptacles having a receiving edge (31) for supporting a support edge (35) of the adapter (25), the receiving edge being formed by at least one web (32, 33) of a grid structure (28) of the support grid, and the support edge having a positioning means for being connected to the at least one web in a form-fitting manner.

3. The charge carrier according to claim 2,
characterized in that
the receiving edge (31) is designed as a closed frame having a frame opening (43) formed in the grid structure (28) of the support grid (11), and the support edge (35) is designed as a support frame having a frame opening (44), the frame openings being arranged so as to at least partially overlap each other.

4. The charge carrier according to claim 3,
characterized in that
both the receiving edge (31) of the adapter receptacles (26) and the support edge (35) of the adapters (25) are annular, the support edge having, as a positioning means, positioning grooves (36) for producing an engagement connection with the grid structure (28) of the support grid (11).

5. The charge carrier according to claim 4,
characterized in that
the support edge (35) of the adapters (25) has contact protrusions (37) for coming to rest on the receiving edge (31) of the adapter receptacles (26).

6. The charge carrier according to claim 1,
characterized in that
the support edge (35) of the adapters (25) has contact protrusions (37) for the arrangement of the object.

7. The charge carrier according to claim 5,
characterized in that
the same contact protrusions (37) serve to come to rest on the receiving edge (31) of the adapter receptacle (26) and to arrange the object.

8. The charge carrier according to claim 1,
characterized in that
a releasable securing means (37, 45) is provided for securing the adapters (25) in a form-fitting manner in the adapter receptacles (26).

9. The charge carrier according to claim 8,
characterized in that
the securing means (38) is designed as a component that can be handled independently of the other components of the charge carrier.

10. The charge carrier according to claim 8,
characterized in that
the securing means (38) connects an arrangement of a plurality of adapters (25) to adapter receptacles (26) of the support grid (11).

11. The charge carrier according to claim 10,
characterized in that
the securing means (38) has at least a locking ridge (39), which engages into a plurality of locking grooves (41) formed in each adapter (25) and arranged in a shared locking row.

12. The charge carrier according to claim 8,
characterized in that
the securing means (45) is formed integrally on the support edge of the adapter.

13. The charge carrier according to claim 12,
characterized in that
the securing means is formed by locking grooves (46).

14. The charge carrier according to claim 13,
characterized in that
the locking grooves (46) are formed in a groove flank of the positioning grooves (36).

15. The charge carrier according to claim 1,
characterized by
a plurality of support grids (11), which are arranged in a stacked arrangement (17) and each of which is connected to adjacent support grids via spacers (12, 19).
